(19) United States
(12) Patent Application Publication
(10) Pub. No.: US 2007/0195110 A1
(43) Pub. Date: Aug. 23, 2007

(54) Image display apparatus and method employing selective smoothing

(75) Inventors: Akihiro Nagase, Tokyo (JP); Jun Someya, Tokyo (JP); Yoshiaki Okuno, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/709,172

(22) Filed: Feb. 22, 2007

(30) Foreign Application Priority Data
Feb. 23, 2006 (JP) 2006-046195

(51) Int. Cl. G09G 5/00

(52) U.S. Cl. 345/611

(57) ABSTRACT

An image display device detects mutually adjacent bright and dark parts of an image and detects fine bright lines in the image. Bright parts of the image that are not fine bright lines are smoothed if they are adjacent to dark parts. This smoothing scheme improves the visibility of dark features on bright backgrounds without impairing the visibility of fine bright lines on dark backgrounds.

### BACKGROUND OF THE INVENTION

1. Field of the Invention

The present invention relates to an image display device and an image display method for digitally processing input image data and displaying the data, and in particular to an image processing device and an image processing method that improves the visibility of small text, fine lines, and other fine features.

2. Description of the Related Art

Japanese Patent Application Publication No. 2002-41025 discloses an image processing device for improving edge rendition so as to improve the visibility of dark features in an image. The device includes means for distinguishing between dark and bright parts of the image from the input image data and generating a control signal that selects bright parts that are adjacent to dark parts, a smoothing means that selectively smoothes the bright parts selected by the control signal, and means for displaying the image according to the image data output from the smoothing means. The smoothing operation compensates for the inherent greater visibility of bright image areas by reducing the brightness of the bright parts of dark-bright boundaries or edges. Since only the bright parts of such edges are smoothed, fine dark features such as dark letters or lines on a bright background do not lose any of their darkness and remain sharply visible.

It has been found, however, that if the image includes fine bright lines (white lines, for example) on a dark background, then the smoothing process may reduce the brightness of the lines across their entire width, so that the lines lose their inherent visibility and become difficult to see.

### SUMMARY OF THE INVENTION

An object of the present invention is to improve the visibility of dark features on a bright background in an image without impairing the visibility of fine bright features on a dark background.

The invented image display device includes:

a feature detection unit for receiving input image data, detecting bright parts of the image that are adjacent to dark parts of the image, and thereby generating a first selection control signal;

a white line detection unit for detecting parts of the image that are disposed adjacently between darker parts of the image, and thereby generating a white line detection signal;

a control signal modification unit for modifying the first selection control signal according to the white line detection signal and thereby generating a second selection control signal;

a smoothing unit for selectively performing a smoothing process on the input image data according to the second selection control signal; and

a display unit for displaying the image data according to the selectively smoothed image data.

In a preferred embodiment, the first selection control signal selects bright or relatively bright parts that are adjacent to dark or relatively dark parts, the control signal modification unit deselects any bright parts identified by the white line detection signal as being adjacently between darker parts, and the smoothing unit smoothes the remaining bright parts selected by the second selection control signal.

The invented image display device improves the visibility of features on a bright background by smoothing and thereby darkening the adjacent parts of the bright background, and avoids impairing the visibility of fine bright features on a dark background by detecting such fine bright features and not smoothing them.

### BRIEF DESCRIPTION OF THE DRAWINGS

In the attached drawings:

FIG. 1 is a block diagram showing an image display device in a first embodiment of the invention;

FIG. 2 is a block diagram showing an exemplary structure of the feature detection unit in FIG. 1;

FIG. 3 is a block diagram showing an exemplary structure of the white line detection unit in FIG. 1;

FIGS. 4A and 4B respectively illustrate the operation of the second-order differentiator and the comparator in FIG. 3;

FIG. 5 is a block diagram showing an exemplary structure of the control signal modification unit in FIG. 1;

FIG. 6 is a block diagram showing an exemplary structure of one of the smoothing units in FIG. 1;

FIG. 7 is a block diagram showing an exemplary structure of a generic filter usable in the smoothing unit in FIG. 6;

FIG. 8 illustrates the filtering characteristic of the generic filter in FIG. 7;

FIGS. 9A, 9B, and 9C show exemplary gray levels that would be displayed without smoothing;

FIGS. 10A and 10B show the filtering characteristic in FIG. 8 applied to red, green, and blue cells;

FIGS. 11A, 11B, and 11C show exemplary image data obtained by selectively smoothing the image data in FIGS. 9A, 9B, and 9C;

FIG. 12 is a flowchart illustrating the operation of the image display device in the first embodiment;

FIG. 13 is a block diagram showing an image display device in a second embodiment;

FIG. 14 is a block diagram showing an exemplary structure of the white line detection unit in FIG. 13;

FIG. 15 is a block diagram showing an image display device in a third embodiment;

FIG. 16 is a block diagram showing an image display device in a fourth embodiment;

FIG. 17 is a block diagram showing an image display device in a fifth embodiment;

FIG. 18 is a block diagram showing an exemplary structure of the feature detection unit in FIG. 17;

FIG. 19 is a block diagram showing an image display device in a sixth embodiment;

FIG. 20 is a block diagram showing an image display device in a seventh embodiment;

FIG. 21 is a block diagram showing an image display device in an eighth embodiment;

FIG. 22 is a block diagram showing an exemplary structure of the feature detection unit in FIG. 21;

FIGS. 23A, 23B, and 23C show exemplary gray levels that would be displayed without smoothing;

FIGS. 24A, 24B, and 24C illustrate pixel brightnesses obtained from image data in FIGS. 23A, 23B, and 23C;

FIGS. 25A, 25B, and 25C show exemplary image data obtained by selectively smoothing the image data in FIGS. 23A, 23B, and 23C; and

FIG. 26 is a flowchart illustrating the operation of the image display device in the eighth embodiment.

### DETAILED DESCRIPTION OF THE INVENTION

Embodiments of the invention will now be described with reference to the attached drawings, in which like elements are indicated by like reference characters.

### First Embodiment

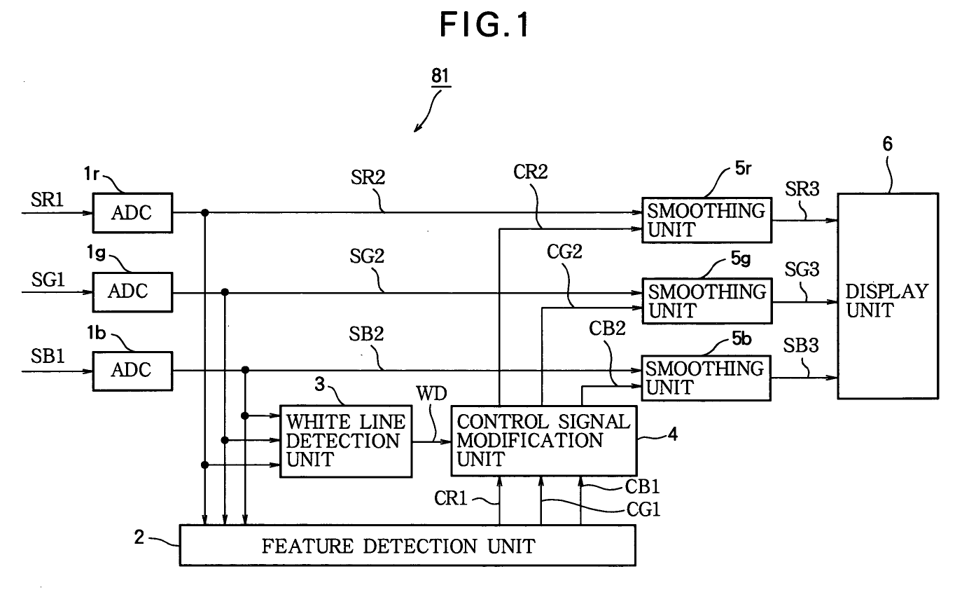

Referring to FIG. 1, the first embodiment is an image display device comprising first, second, and third analog-to-digital converters (ADCs) 1r, 1g, 1b, a feature detection unit 2, a white line detection unit 3, a control signal modification unit 4, first, second, and third smoothing units 5b, 5r, 5g, and a display unit 6.

The analog-to-digital converters 1r, 1g, 1b, feature detection unit 2, white line detection unit 3, control signal modification unit 4, and smoothing units 5b, 5r, 5g constitute an image processing apparatus. These units and the display unit 6 constitute an image display device 81.

The analog-to-digital converters 1r, 1g, 1b receive respective analog input signals SR1, SG1, SB1 representing the three primary colors red, green, and blue, sample these signals at a frequency suitable for the signal format, and generate digital image data (color data) SR2, SG2, SB2 representing respective color values of consecutive picture elements or pixels.

From these image data SR2, SG2, SB2, the feature detection unit 2 detects bright-dark boundaries or edges in each primary color component (red, green, blue) of the image and generates first selection control signals CR1, CG1, CB1 indicating the bright parts of these edges. The first selection control signals CR1, CG1, CB1 accordingly indicate bright parts of the image that are adjacent to dark parts, bright and dark being determined separately for each primary color.

From the same image data SR2, SG2, SB2, the white line detection unit 3 detects narrow parts of the image that are disposed adjacently between darker parts of the image and generates a white line detection signal WD identifying these parts. The identified parts need not actually be white lines; they may be white dots, for example, or more generally dots, lines, letters, or other fine features of any color and brightness provided they are disposed on a darker background. The white line detection unit 3 does not process the three primary colors separately but identifies darker parts of the image on the basis of combined luminance values.

The control signal modification unit 4 modifies the first selection control signals CR1, CG1, CB1 output from the feature detection unit 2 on the basis of the white line detection signal WD output from the white line detection unit 3 to generate and output second selection control signals CR2, CG2, CB2.

The smoothing units 5r, 5g, 5b perform a smoothing process on the red, green, and blue color data SR2, SG2, SB2 selectively, according to the second control signals CR2, CG2, CB2, to generate and output selectively smoothed image data SR3, SG3, SB3.

The display unit 6 displays an image according to the selectively smoothed image data SR3, SG3, SB3 output by the smoothing units 5r, 5g, 5b.

The display unit 6 comprises a liquid crystal display (LCD), plasma display panel (PDP), or the like having a plurality of pixels arranged a matrix. Each pixel is a set of three sub-pixels or cells that display respective primary colors red (R), green (G), and blue (B). The three cells may be arranged in, for example, a horizontal row with the red cell at the left and the blue cell at the right.

The input image signals SR1, SB1, SG1 are sampled at a frequency corresponding to the pixel pitch, so that the image data SR2, SG2, SB2 obtained by analog-to-digital conversion are pixel data representing the brightness of each pixel in each primary color.

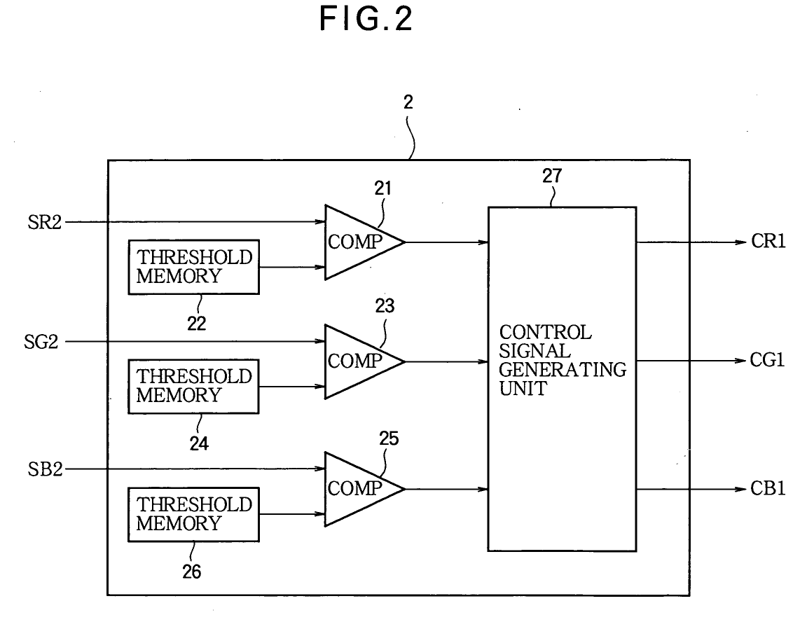

Referring now to the block diagram in FIG. 2, the feature detection unit 2 comprises three comparators (COMP) 21, 23, 25, three threshold memories 22, 24, 26, and a selection control signal generating unit 27.

The threshold memories 22, 24, 26 store preset threshold values. The comparators 21, 23, 25 receive the red, green, and blue image data SR2, SG2, SB2, compare these data with the threshold values stored in the threshold memories 22, 24, 26, and output signals indicating the comparison results. These signals identify the image data SR2, SG2, SB2 as being dark if they are equal to or less than the threshold value, and bright if they exceed the threshold value.

The control signal generator 27 carries out predefined calculations on the signals representing the comparison results from the comparators 21, 23, 25 to generate and output the first selection control signals CR1, CG1, CB1. For example, the control signal generator 27 may include a microprocessor with memory that temporarily stores the comparison results, enabling it to generate the control signals for a given pixel from the comparison results of that pixel and its adjacent pixels.

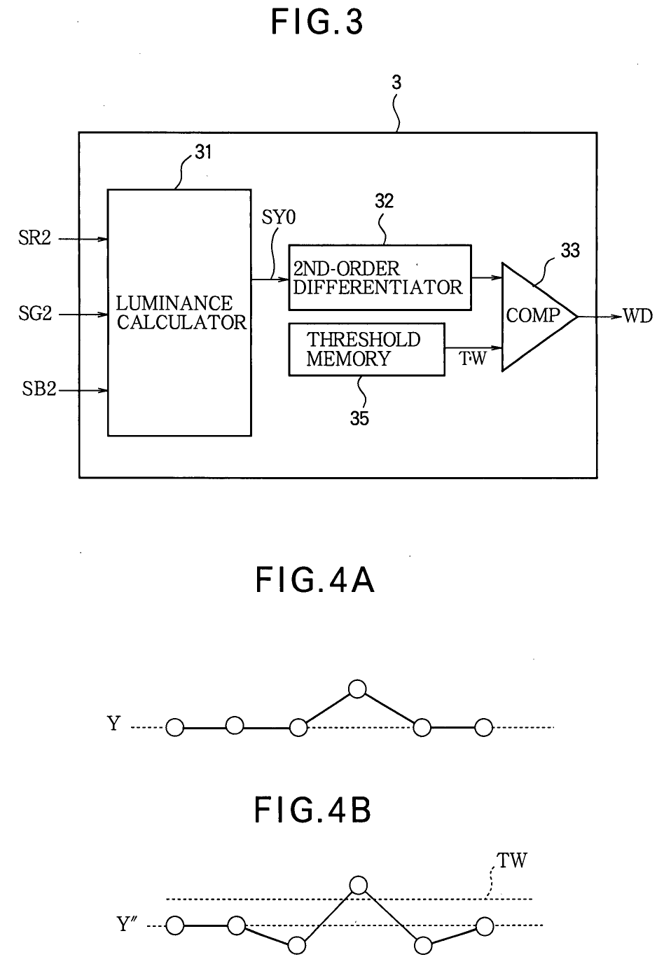

Referring to FIG. 3, the white line detection unit 3 comprises a luminance calculator 31, a second-order differentiator 32, a comparator 33, and a threshold memory 35.

The luminance calculator 31 takes a weighted sum of the three color image data values SR2, SG2 and SB2 to calculate the luminance of a pixel. The weight ratio is preferably about ¼:½:¼. If these simple fractions are used, the luminance SY0 can be calculated by the following equation.

SY0={SR2+(2×SG2)+SB2}/4

The second-order differentiator 32 takes the second derivative of the luminance values calculated by the luminance calculator 31. The second derivative value for a pixel can be obtained by, for examples, subtracting the mean luminance level of pixels on both sides (the preceding and following pixels) from the luminance level of the pixel in question. In this method, if the luminance of the pixel is Yi, the luminance of the preceding pixel is Y(i−1), and the luminance of the following pixel is Y(i+1), then the second derivative Y″ can be obtained from the following equation.

Y″=Yi−{Y(i−1)+Y(i+1)}/2

The threshold memory 35 compares the second derivative output from the second-order differentiator 32 with a predefined threshold value TW stored in the threshold memory 35 and outputs the white line detection signal WD. When the second derivative exceeds the threshold value TW, the white line detection signal WD receives a first value (‘1’), otherwise, the signal WD receives a second value (‘0’).

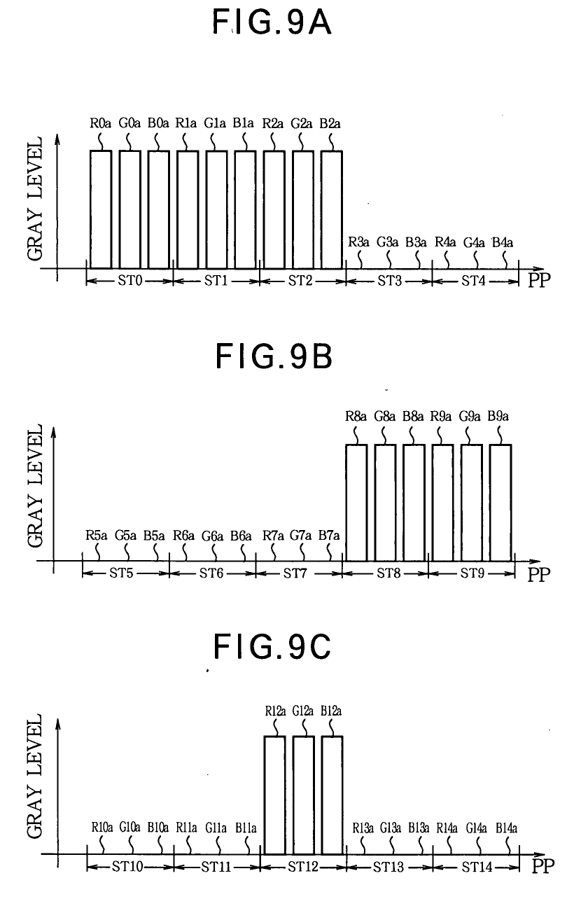

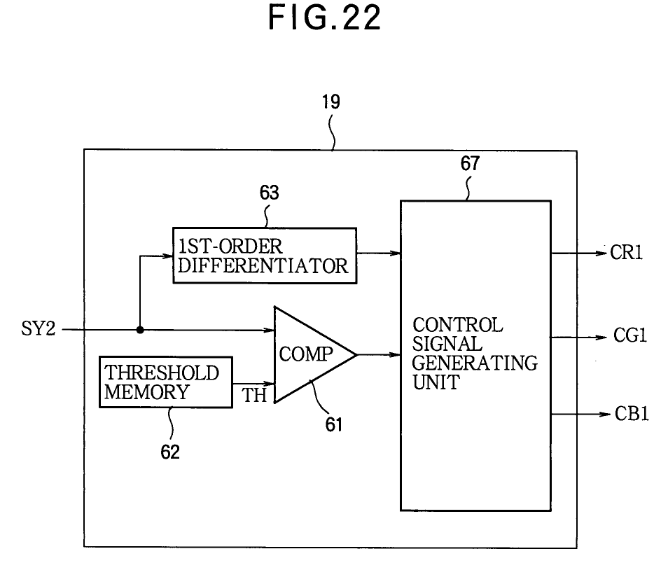

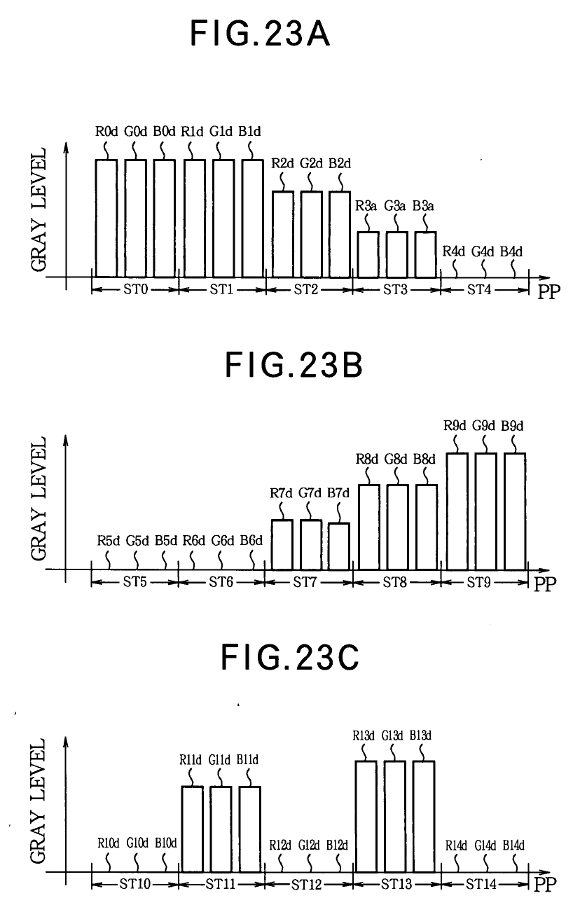

The luminance values Y in FIG. 4A illustrate a typical white line one pixel wide on a darker background. The corresponding second derivative values Y″ are shown in FIG. 4B. In this example the third pixel from the right is identified as part of a white line because its second derivative exceeds the threshold TW. Further examples will be shown in FIGS. 9C and 23C.

The white line detection unit 3 may detect white lines in various other ways. By one other possible criterion, a pixel is identified as belonging to a white line if its luminance value is greater than the luminance values of the pixel horizontally preceding it and the pixel horizontally following it. This criterion identifies bright features with a horizontal width of one pixel. Another possible criterion identifies a series of up to N horizontally consecutive pixels as belonging to a white line if their luminance values are all greater than the luminance values of the pixel horizontally preceding the series and the pixel horizontally following the series, where N is a positive integer such as two. This criterion identifies bright features with horizontal widths of up to N pixels.

The control signal modification unit 4 modifies the first selection control signals CR1, CG1, CB1 for the three cells in each pixel according to the white line detection signal WD for the pixel to generate second selection control signals CR2, CG2, CB2 for the three cells.

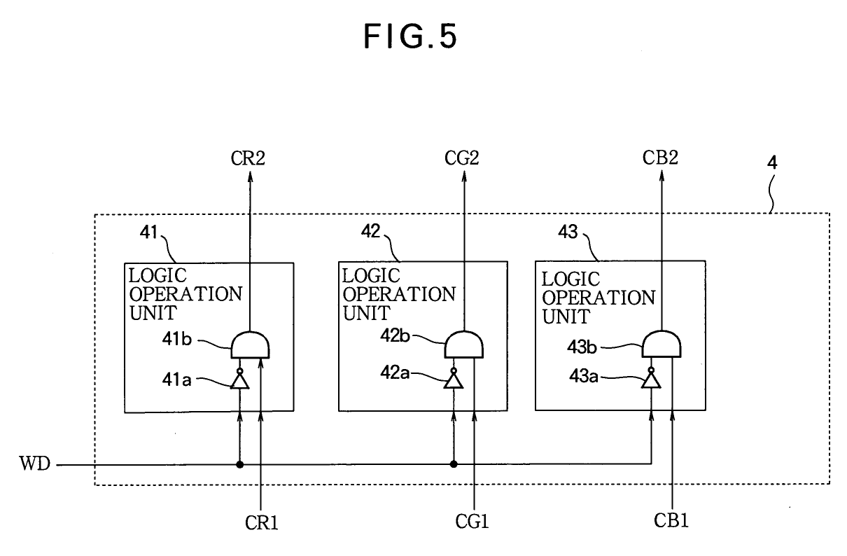

Referring to FIG. 5, the control signal modification unit 4 comprises three logic operation units 41, 42, 43 that receive respective first selection control signals CR1, CG1, CB1. All three logic operation units 41, 42, 43 also receive the white line detection signal WD from the white line detection unit 3. The logic operation units 41, 42, 43 perform predefined logic operations on these signals to set the second selection control signals CR2, CG2, CB2 to the first value (‘1’) or second value (‘0’).

The logic operation units 41, 42, 43 comprise respective inverters 41a, 42a, 43a and respective AND gates 41b, 42b, 43b. The inverters 41a, 42a, 43a invert the white line detection signal WD. The AND gates 41b, 42b, 43b carry out a logical AND operation on the outputs from the inverters 41a, 42a, 43a, and the first selection control signals CR1, CG1, CB1, and output the second selection control signals CR2, CG2, CB2.

With this structure, when the white line detection signal WD has the second value ‘0’ (no white line is detected), the first selection control signals CR1, CG1, CB1 pass through the control signal modification unit 4 without change and become the second selection control signals CR2, CG2, CB2, respectively. When the white line detection signal WD has the first value ‘1’ (a white line is detected), the second selection control signals CR2, CG2, CB2 have the second value ‘0’, regardless of the value of the first selection control signals CR1, CG1, CB1.

In a modification of this structure, the three inverters 41a, 42a, 43a are replaced by a single inverter.

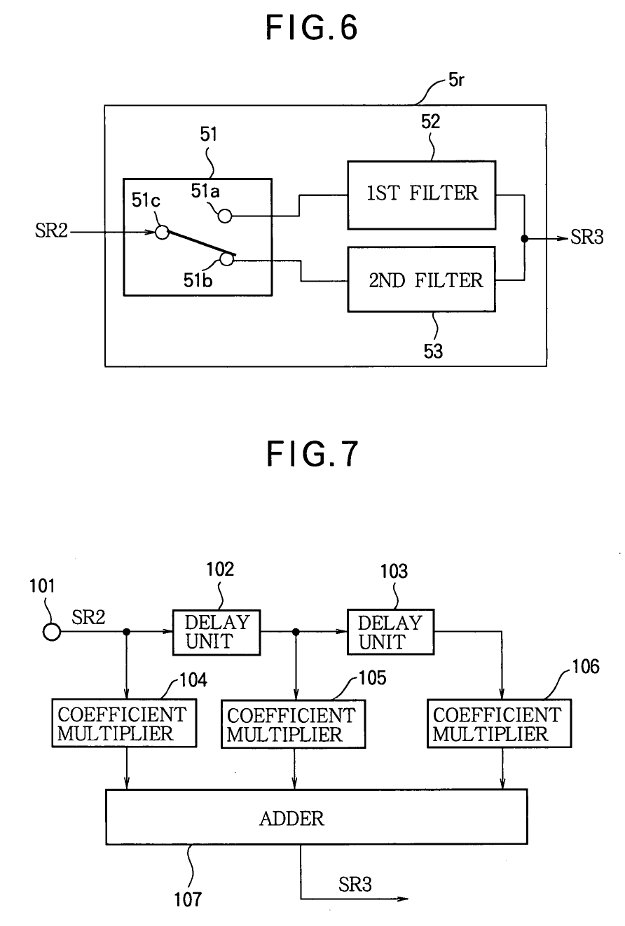

The three smoothing units 5r, 5g, 5b have identical internal structures, which are illustrated for the first (red) smoothing unit 5r in FIG. 6. Each smoothing unit comprises a selector 51, a first filter 52, and a second filter 53. The selector 51 is a switch with two output terminals 51a, 51b and one input terminal 51c. For the first smoothing unit 5r, the red image data SR2 are supplied to the input terminal 51c. The first filter 52 and second filter 53 are connected to the first and second output terminals 51a and 51b, respectively.

The first filter 52 has a first filtering characteristic A; the second filter 53 has a second filtering characteristic B. The second filtering characteristic B has less smoothing effect than the first filtering characteristic A. For example, the second filtering characteristic B may be a simple pass-through characteristic in which no filtering is carried out and input becomes output without alteration. The smoothing effect of filtering characteristic B is then zero.

The selector 51 is controlled by the appropriate second selection control signal (in this case, CR2) from the control signal modification unit 4. Specifically, the selector 51 is controlled to select the first filter 52 when the second selection control signal CR2 has the first value ‘1’, and to select the second filter 53 when the second selection control signal CR2 has the second value ‘0’. Input of the image data SR2 and the corresponding second selection control signal CR2 to the selector 51 is timed so that both input values apply to the same pixel. The image data input may be delayed for this purpose. A description of the timing control scheme is omitted so as not to obscure the invention with unnecessary detail.

FIG. 7 illustrates a generic filter structure that can be used for both the first filter 52 and the second filter 53 in FIG. 6. The filter in FIG. 7 comprises an input terminal 101 that receives the relevant image data (e.g., SR2), a delay unit 102 that delays the image data received at the input terminal 101 by one pixel period, another delay unit 103 that receives the output from delay unit 102 and delays it by one more pixel period, coefficient multipliers 104, 105, 106 that multiply the input image data (SR2) and the data appearing at the output terminals of the delay units 102, 103 by weighting coefficients, and a three-input adder 107 that totals the outputs from the coefficient multipliers 104, 105, 106.

The coefficient used in the second coefficient multiplier 105 can be expressed as (1−x−y), where x is the coefficient used in the third coefficient multiplier 106 and y is the coefficient used in the first coefficient multiplier 104, the values of x and y both being equal to or greater than zero and less than one and their sum being less than one.

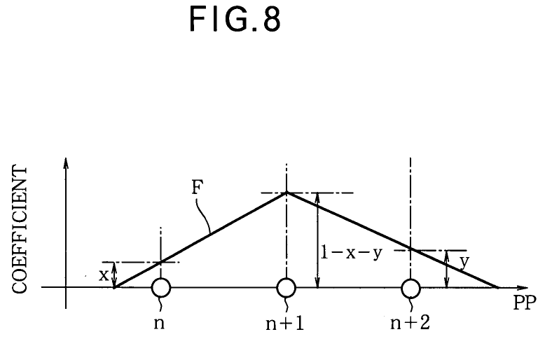

FIG. 8 is a drawing illustrating the filtering characteristic F of this filter. The vertical axis represents weighting coefficient value, the horizontal axis represents horizontal pixel position PP, the pixel being processed is in position (n+1), the preceding (left adjacent) pixel is in position n, and the following (right adjacent) pixel is in position (n+2). When the data value of the pixel being processed (n+1) is obtained from delay unit 102 in FIG. 7, the data value of the preceding pixel (n) is simultaneously obtained from delay unit 103 and the data value of the following pixel (n+2) is obtained the input terminal 101.

The other smoothing units 5g, 5b are controlled similarly by second selection control signals CG2 and CB2.

FIGS. 9A, 9B, and 9C are graphs illustrating exemplary gray levels that represent cell brightness at various bright-dark edges in the input image data before smoothing. In FIGS. 9A, 9B, and 9C, the vertical axis represents gray level, indicating brightness in each of the three primary colors, and the horizontal axis represents horizontal pixel position PP on the screen of the display unit 6. R0a to R14a represent red cells, G0a to G14a represent green cells, and B0a to B14 represent blue cells. FIG. 9A illustrates a boundary between a bright area on the left and a dark area on the right. FIG. 9B illustrates a boundary between a dark area on the left and a bright area on the right. FIG. 9C illustrates part of a fine white line one pixel (three cells) wide on a dark background. Cell sets ST0 to ST14 include three consecutive cells each, each cell set corresponding to one pixel.

In the example in FIG. 9A, the feature detection unit 2 identifies the cells R0a, G0a, B0a, R1a, G1a, B1a, R2a, G2a, B2a in cell sets ST0, ST1, and ST2 as bright, the cells R3a, G3a, B3a, R4a, G4a, B4a in cell sets ST3 and ST4 as dark, and the cells R2a, G2a, B2a in cell set ST2 as being the bright part of a bright-dark boundary, that is, a bright part adjacent to a dark part. As a result, the first selection control signals CR1, CG1, CB1 are given the first value ‘1’ for the cells R2a, G2a, B2a in cell set ST2 and the second value ‘0’ for the cells in the other cell sets.

In the example in FIG. 9B, the feature detection unit 2 identifies the cells R5a, G5a, B5a, R6a, G6a, B6a, R7a, G7a, B7a in cell sets ST5, ST6, and ST7 as dark, the cells R8a, G8a, B8a, R9a, G9a, B9a in cell sets ST8 and ST9 as bright, and the cells R8a, G8a, B8a in cell set ST8 as a bright part adjacent to a dark part. As a result, the first selection control signals CR1, CG1, CB1 are given the first value ‘1’ for the cells R8a, G8a, B8a in cell set ST8 and the second value ‘0’ for the cells in the other cell sets.

In the example in FIG. 9C, the feature detection unit 2 identifies the cells R10a, G10a, B10a, R11a, G11a, B11a, R13a, G13a, B13a, R14a, G14a, B14a in cell sets ST10, ST11, ST13, and ST14 as dark, the cells R12a, G12a, B12a in cell set ST12 as bright, and the cells R12a, G12a, B12a in cell set ST12 as a bright part adjacent to a dark part. As a result, the first selection control signals CR1, CG1, CB1 are given the first value ‘1’ for the cells R12a, G12a, B12a in cell set ST12 and the second value ‘0’ for the cells in the other cell sets.

The cell set ST12 (Rl2a, G12a, B12a) which is the bright part in FIG. 9C has a gray level significantly higher than that of the adjacent dark cell sets ST11 (R11a, G11a, B11a) and ST13 (R13a, G13a, B13a). The second derivative result Y″ calculated in the second-order differentiator 32 exceeds the threshold TW stored in the threshold memory 35, so cell set ST12 is detected as a white line in the white line detection unit 3. As a result, the white line detection signal WD output from the white line detection unit 3 has the first value ‘1’ for cell set ST12 and the second value ‘0’ for the other cell sets.

As described above, the cells R2a, G2a, B2a in cell set ST2 in FIG. 9A and the cells R8a, G8a, B8a in cell set ST8 in FIG. 9B are detected as being bright parts adjacent to dark parts in the feature detection unit 2, but are not detected as white lines. The first selection control signals CR1, CG1, CB1, which have the first value ‘1’, pass through the control signal modification unit 4 without change and become the second selection control signals CR2, CG2, CB2 input to the smoothing units 5r, 5g, 5b.

The cells R12a, G12a, B12a in cell set ST12 in FIG. 9C are detected as a bright part adjacent to a dark part in the feature detection unit 2, so their first selection control signals CR1, CG1, CB1 have the first value ‘1’. These cells are also detected in the white line detection unit 3 as belonging to a white line, however, so their white line detection signal WD has the first value ‘1’, and the second selection control signals CR2, CG2, CB2 output from the control signal modification unit 4 for these cells consequently have the second value ‘0’.

As seen in the above example, in a white line, even though the first selection control signals CR1, CG1, CB1 output from the feature detection unit 2 may have the first value ‘1’ and select filtering characteristic A, the second selection control signals CR2, CG2, CB2 supplied to the smoothing units 5r, 5g, 5b have the second value ‘1’ and select filtering characteristic B.

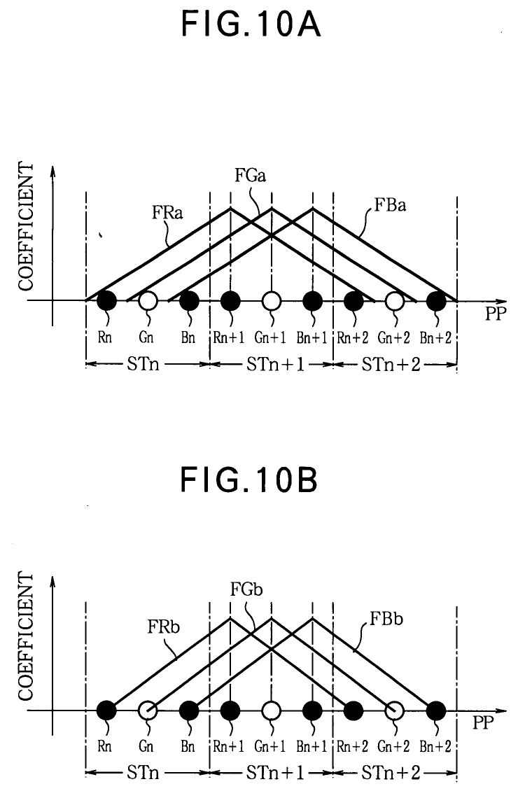

FIGS. 10A and 10B illustrate filtering characteristics A and B for red, green, and blue cells, using the generic filtering characteristic shown in FIG. 8. The vertical axis of each graph represents weighting coefficient value, and the horizontal axis represents horizontal pixel position. The cell sets at pixel positions n, (n+1), (n+2) are represented by STn, STn+1, and STn+2, respectively.

The symbols FRa, FGa, and FBa in FIG. 10A indicate filtering characteristic A as applied to the red, green, and blue cells Rn+1, Gn+1, and Bn+1 in cell set STn+1 by the first filter 52 in the smoothing units 5r, 5g, 5b. The weighting coefficients of these cells are less than unity and the weighting coefficients of the cells Rn, Gn, Bn, Rn+1, Gn+2, Bn+2 in the adjacent cell sets STn and STn+2 are greater than zero. The symbols FRb, FGb, and FBb in FIG. 10B indicate filtering characteristic B as applied to the same cells by the second filter 53 in the smoothing units 5r, 5g, 5b. The weighting coefficients in cell set STn+1 are equal to unity and the weighting coefficients in the adjacent cell sets STn and STn+2 are zero.

If filtering characteristic A (x>0, y>0, x=y) were to be applied when the pixel of cell set STn+1 was a white (bright) pixel and pixels in the adjacent cell sets STn and STn+2 were black (dark) pixels, the gray level of the cell data in cell set STn+1 would decrease due to smoothing. Conversely, if the pixel in cell set STn+1 were black (dark) and the pixels in the adjacent cell sets STn and STn+2 were white (bright), the (dark) gray level of the cell data in cell set STn+1 would increase due to smoothing.

When filtering characteristic B (x=0, y=0) is applied, no smoothing is carried out and the input data SR2 become the output SR3 without change. For example, if the pixel in cell set STn+1 is white (bright) and the pixels in cell sets STn and STn+2 are black (dark), the gray level in cell set STn+1 (the bright part) does not decrease. If the pixel in cell set STn+1 is black (dark) and the pixels in cell sets STn and STn+2 are white (bright), the gray level in cell set STn+1 (the dark part) does not increase.

A filter having the characteristic FRa (filtering characteristic A) shown in FIG. 10A is used as the first filter 52 in the smoothing unit 5r, and a filter having the characteristic FRb (filtering characteristic B) shown in FIG. 10B is used as the second filter 53. Similarly, in smoothing unit 5g and smoothing unit 5b, filters having the characteristics FGa and FBa (filtering characteristic A) shown in FIG. 10A are used as the first filter 52 and filters having the characteristics FGb and FBb (filtering characteristic B) shown in FIG. 10B are used as the second filter 53. The selector S1 in each smoothing unit is controlled by the second selection control signals CR2, CG2, CB2 to select either the first filter 52 or second filter 53 according to characteristics of the input image.

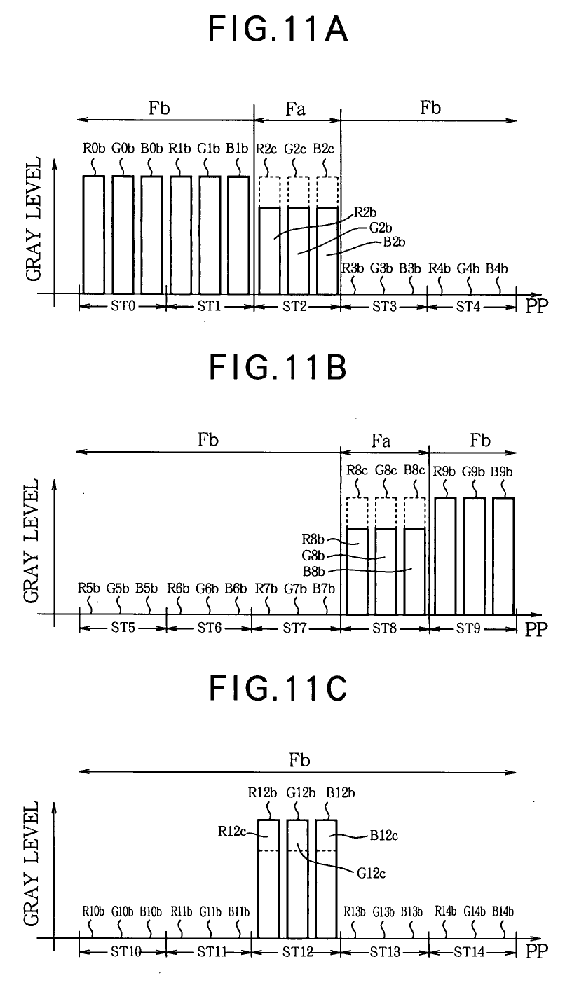

The effects of selective smoothing on the image data shown in FIGS. 9A, 9B and 9C by the smoothing units 5r, 5g, 5b under control by the feature detection unit 2, white line detection unit 3, and control signal modification unit 4 are illustrated in FIGS. 11A, 11B, and 11C. The vertical axis represents gray level and the horizontal axis represents horizontal pixel position PP on the screen of the display unit 6. R0b to R14b represent red cells, G0b to G14b represent green cells, and B0b to B14b represent blue cells. The symbol Fa indicates that the data of the cell set shown below were processed by the first filter 52 (with filtering characteristic A); the symbol Fb indicates that the data of the cell set shown below were processed by the second filter 53 (with filtering characteristic B).

When the image data shown in FIGS. 9A, 9B, and 9C are input, the second selection control signals CR2, CG2, CB2 output from the control signal modification unit 4 have the first value ‘1’ for the cells R2a, G2a, B2a, R8a, G8a, B8a in cell sets ST2 and ST8. As a result, the selector 51 selects the first filter 52, and the image data are smoothed with filtering characteristic A.

For the other cell sets ST0, ST1, ST3 to ST7, and ST9 to ST14, the second selection control signals CR2, CG2, CB2 output from the control signal modification unit 4 have the second value ‘0’. As a result, the selector 51 selects the second filter 53, and the image data are not smoothed.

As a result of the selective smoothing described above, the gray level decreases for the image data in the cells R2b, G2b, B2b, R8b, G8b, B8b in cell sets ST2 and ST8, as shown in FIGS. 11A and 11B. The decrease is represented by symbols R2c, G2c, B2c, R8c, G8c, and B8c.

In FIG. 11C, the gray level does not decrease for the image data of the cells R12b, G12b, B12b in cell set ST12. If the selector 51 were to be controlled by the first selection control signals CR1, CG1, CB1 output from the feature detection unit 2 without using the white line detection unit 3, the gray level would decrease by the amount represented by symbols R12c, G12c and B12c in FIG. 11C. The present invention avoids this decrease by using the white line detection unit 3 in order to improve visibility of white lines on a dark background.

As described above, in this embodiment, the image data shown in FIGS. 9A, 9B, and 9C are subjected to selective smoothing by the smoothing units 5r, 5g, 5b, based on the second selection control signals CR2, CG2, CB2 output from the control signal modification unit 4. As a result, at a bright-dark boundary in an image, selective smoothing is carried out only on the bright part of the boundary, and only if the bright part is not part of a white line. Accordingly, neither dark features on a bright background nor fine bright features on a dark background are smoothed; both are displayed sharply, and in particular the vividness of small bright characters and fine bright lines is not compromised.

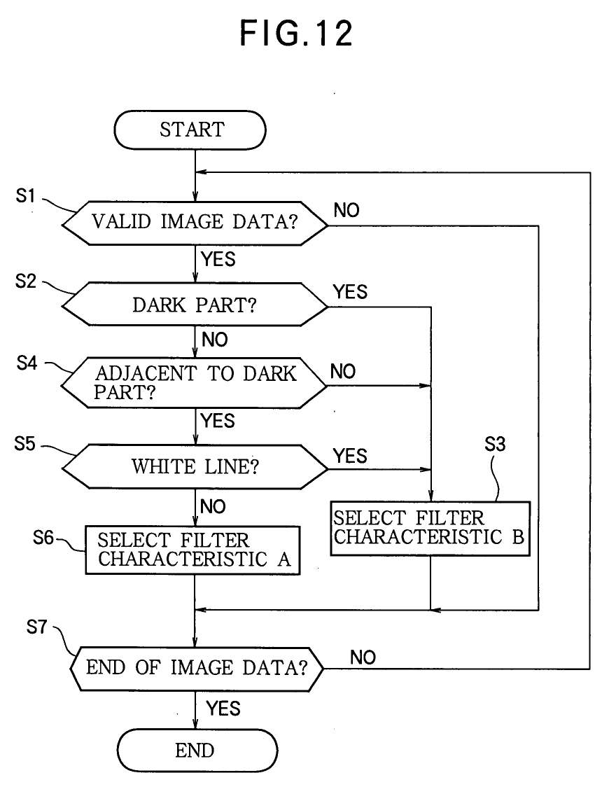

Next, the procedure by which the feature detection unit 2, white line detection unit 3, and control signal modification unit 4 control the smoothing units 5r, 5g, 5b will be described with reference to the flowchart shown in FIG. 12. This control procedure can be implemented by software, that is, by a programmed computer.

The feature detection unit 2 determines if the input image data (SR2, SG2, SB2) belong to a valid image interval (step S1). When they are not within the valid image interval, that is, when the data belong to a blanking interval, the process proceeds to step S7. Otherwise, the process proceeds to step S2.

In step S2, the comparators 21, 23, 25 compare the input image data with the threshold values stored in the threshold memories 22, 24, 26 to determine if the data represent a dark part of the image or not. The following description relates to the red input image data SR2 and control signals CR1, CR2; similar control is carried out for the other primary colors (green and blue).

If the SR2 value exceeds the threshold and is therefore not a dark part of the red component of the image (and is hence a bright part; No in step S2), the process proceeds to step S4. In step S4, the red image data preceding and following the input image data SR2 are examined to determine if SR2 constitutes a bright part adjacent to a dark part or not. If the input image data SR2 constitutes a bright part adjacent to a dark part (Yes in step S4), the process proceeds to step S5.

In step S5, the white line detection unit 3 obtains luminance data SY0 from the input image data SR2, SG2, SB2 by using the luminance calculator 31. The comparator 33 compares a second derivative Y″ obtained from the second-order differentiator 32 with the threshold TW stored in the threshold memory 35, to determine whether the current pixel is part of a white line or not.

When the current pixel is determined not to represent a white line (No in step S5), the process proceeds to step S6, and the first filter 52 (with filtering characteristic A) is selected. Specifically, the SR2 value represents a bright part adjacent to a dark part (Yes in step S4), so the first selection control signal CR1 output from the feature detection unit 2 has the first value, and the current pixel is not part of a white line (No in step S5), so the second selection control signal CR2 has the same value as the first selection control signal CR1. The selector 51 in the smoothing unit 5r accordingly selects the first filter 52 (step S6) and the red image data filtered with filtering characteristic A are supplied as image data SR3 to the display unit 6.

If the red input image data SR2 represents a dark part of the image in (Yes in step S2), or represents a bright part of the image that is not adjacent to a dark part (No in step S4), or represents a bright part that is adjacent to a dark part but also forms part of a white line (Yes in step S5), the process proceeds to step S3. In step S3, regardless of the value of the first selection control signals CR1, the second selection control signal CR2 has the second value, causing the selector 51 in the smoothing unit 5r to select the second filter 53, and the red image data filtered with filtering characteristic B are supplied as image data SR3 to the display unit 6.

Step S3 is carried out in different ways depending on the step from which it is reached. The second control signal CR2 is the logical AND of the first control signal CR1 and the inverse of the white line detection signal WD. If the input image data SR2 is determined to represent a dark part of the image (Yes in Step S2) or a bright part that is not adjacent to a dark part (No in step S4), then the first control signal CR1 has the second value ‘0’, so the second control signal CR2 necessarily has the second value ‘0’. If the current pixel is determined to be part of a white line (Yes in step S5), then the white line detection signal WD has the first value ‘1’, its inverse has the second value ‘0’, and the second control signal CR2 necessarily has the second value ‘0’, regardless of the value of the first control signal CR1.

After step S3 or step S6, whether the end of the image data has been reached is determined (step S7). If the end of the image data has been reached (Yes in step S7), the process ends. Otherwise (No in step S7), the process returns to step S1 to detect further image data.

By following the above sequence of operations the first embodiment smoothes only image data representing a bright part that is adjacent to a dark part but is not part of a white line. The added white-line restriction does not impair the visibility of dark features on a bright background, but it maintains the vividness of fine bright features on a dark background by assuring that they are not smoothed.

The above embodiment has a configuration in which the smoothing units 5r, 5g, 5b each have two filters 52, 53 and a selector 51 that selects one of the two filters. In an alternative configuration the smoothing units 5r, 5g, 5b each have three or more filters, one of which is selected according to the image characteristics. If there are N filters, where N is an integer greater than two, then the first selection control signals CR1, CG1, CB1 and the second selection control signals CR2, CG2, CB2 are multi-valued signals having N values that select one of N filters according to image characteristics detected by the feature detection unit 2. When a white line is detected in the white line detection unit 3, the second selection control signals CR2, CG2, CB2 are set to a value that selects a filter having a filtering characteristic with minimal or no smoothing effect, regardless of the value of the first selection control signals CR1, CG1, CG1.

Alternatively, instead of selecting one filter from a plurality of filters, the smoothing units 5r, 5g, 5b can use one filter having a plurality of selectable filtering characteristics. In this case, the second selection control signals CR2, CG2, CB2 switch the filtering characteristic. The switching of filtering characteristics can be implemented by switching the coefficients in the coefficient multipliers in FIG. 7, for example.

In the above embodiment, dark parts of an image are recognized when the image data SR2, SG2, SB2 of the three cells in a cell set input to the feature detection unit 2 are lower than the threshold values stored in the threshold memories 22, 24, 26. An alternative method is to compare the minimum value of the image data SR2, SG2, SB2 of the three cells in the cell set with a predefined threshold. When the minimum data value is lower than the threshold, the image data of the three cells in the cell set are determined to represent a dark part of the image; otherwise, the image data are determined to represent a bright part of the image. Another alternative method is to compare the maximum value of the image data SR2, SG2, SB2 of the three cells in the cell set with a predefined threshold. When the maximum data value exceeds the threshold, the image data of the three cells in the cell set are determined to represent a bright part of the image; otherwise, the image data are determined to represent a dark part of the image.

In yet another alternative scheme, pixels representing bright parts adjacent to dark parts are determined on the basis only of the green image data SG2. The results are applied to the image data SR2, SG2, SB2 of all three cells of each pixel.

In still another alternative scheme, the threshold used to determine bright parts is different from the threshold used to determine dark parts.

In another modification of the first embodiment, adjacency is detected vertically as well as (or instead of) horizontally, and filtering is performed vertically as well as (or instead of) horizontally.

### Second Embodiment

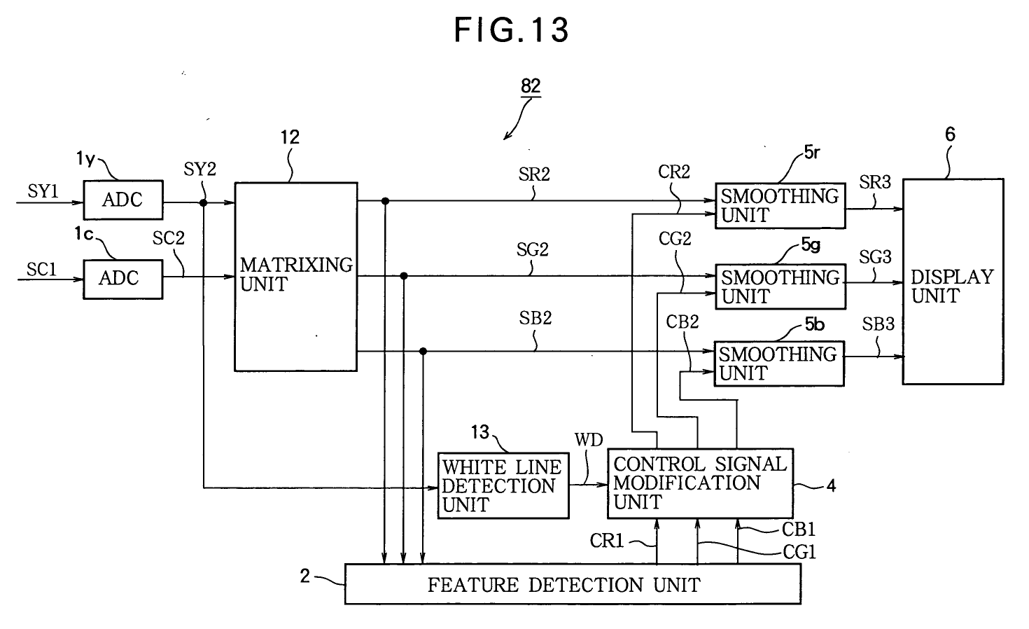

FIG. 13 is a block diagram showing an image display device 82 according to a second embodiment of the invention. The image display device 82 is generally similar to the image display device 81 in FIG. 1, but differs in the following points. The image display device 82 receives an analog luminance signal SY1 and an analog chrominance signal SC1 (the latter including a pair of color difference signals BY and RY, representing a red color difference and a blue color difference) as input image signals instead of the red, green, and blue image signals SR1, SG1, SB1 in FIG. 1. The image display device 82 accordingly has two analog-to-digital converters 1y, 1c instead of the three analog-to-digital converters 1r, 1g, 1b in FIG. 1, and additionally comprises a matrixing unit 12. The white line detection unit 13 in the second embodiment also differs from the white line detection unit 3 in FIG. 1.

Analog-to-digital converter 1y converts the analog luminance signal SY1 to digital luminance data SY2.

Analog-to-digital converter 1c converts the analog chrominance signal SC1 to digital color difference data SC2.

The matrixing unit 12 receives the luminance data SY2 and color difference data SC2 and outputs red, green, and blue image data (color data) SR2, SG2, SB2.

Whereas the white line detection unit 3 in FIG. 1 receives the red, green, and blue image data SR2, SG2, SB2, the white line detection unit 13 in FIG. 13 receives the luminance data SY2.

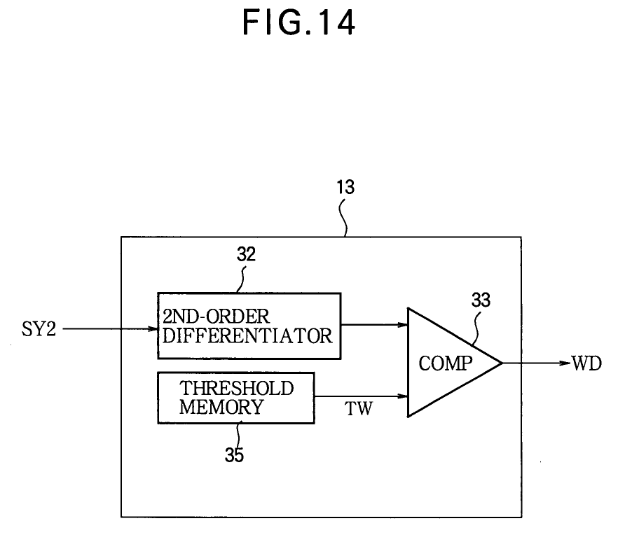

FIG. 14 is a block diagram showing the structure of the white line detection unit 13 in the image display device 82. The white line detection unit 13 in FIG. 14 dispenses with the luminance calculator 31 in FIG. 3 and simply receives the luminance data SY2. The second-order differentiator 32, comparator 33, and threshold memory 35 operate on the luminance data SY2 as described in the first embodiment.

The operation of the image display device 82 in FIG. 13 is generally similar to the operation of the image display device 81 in FIG. 1, but differs on the following points. The luminance signal SY1 is input to analog-to-digital converter 1y, and the chrominance signal SC1 is input to analog-to-digital converter 1c. The analog-to-digital converters 1y, 1c sample the input luminance signal SY1 and chrominance signal SC1 at a predefined frequency to convert them to consecutive digital luminance data SY2 and color difference data SC2 on a pixel-by-pixel basis. The luminance data SY2 output from analog-to-digital converter 1y are sent to the matrixing unit 12 and white line detection unit 13. The color difference data SC2 output from analog-to-digital converter 1c are sent to the matrixing unit 12. The matrixing unit 12 generates red, green, and blue image data SR2, SG2, SB2 from the input luminance data SY2 and color difference data SC2. The red, green, and blue image data SR2, SG2, SB2 are input to the feature detection unit 2 and the smoothing units 5r, 5g, 5b.

Other operations proceed as described in the first embodiment. The modifications described in the first embodiment are applicable to the second embodiment as well.

The invention can accordingly be applied to apparatus receiving a so-called separate video signal comprising a luminance signal SY1 and chrominance signal SC1 instead of three primary color image signals SR1, SG1, SB1.

### Third Embodiment

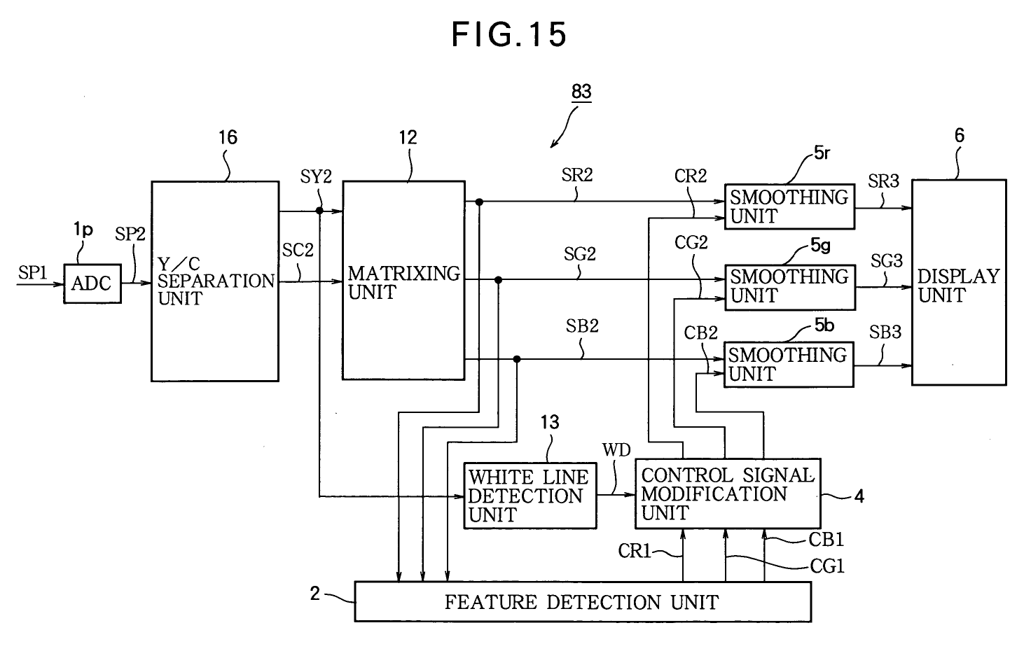

The image display device 83 in the third embodiment, shown in FIG. 15, is generally similar to the image display device 82 in FIG. 13 except that it receives an analog composite video signal SP1 instead of separate luminance and chrominance signals SY1 and SC1. The image display device 83 accordingly has a single analog-to-digital converter 1p instead of the two analog-to-digital converters 1y and 1c in FIG. 13, and has an additional luminance-chrominance (Y/C) separation unit 16.

Analog-to-digital converter lp converts the analog composite video signal SP1 to digital composite video data SP2.

The luminance-chrominance separation unit 16 separates luminance data SY2 and color difference data SC2 from the composite video data SP2. As in the second embodiment (FIG. 13), the luminance data SY2 are supplied to the matrixing unit 12 and the white line detection unit 13. The color difference data SC2 are supplied to the matrixing unit 12.

The operation of the image display device 83 shown in FIG. 15 is generally similar to the operation of the image display device 82 shown in FIG. 13, expect for the following points.

The composite video signal SP1 is input to the analog-to-digital converter 1p. The analog-to-digital converter 1p samples the composite signal SP1 at a predefined frequency to convert the signal to digital composite video data SP2. The composite video data SP2 are input to the luminance-chrominance separation unit 16, where they are separated into luminance data SY2 and color difference data SC2. The luminance data SY2 output from the luminance-chrominance separation unit 16 are sent to the matrixing unit 12 and the white line detection unit 13, and the color difference data SC2 are input to the matrixing unit 12. Other operations are similar to the operations described in the first and second embodiments.

The invention is accordingly also applicable to apparatus receiving an analog composite video signal SP1.

### Fourth Embodiment

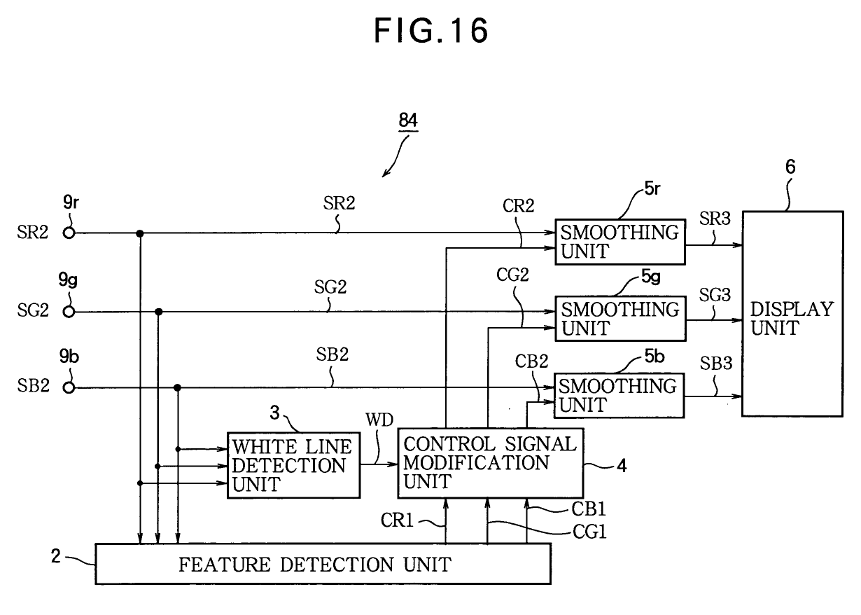

In the first to third embodiments, the input signals are analog signals, but the invention is also applicable to configurations in which digital image data are input. FIG. 16 illustrates an image display device 84 of this type according a fourth embodiment of the invention. The image display device 84 of FIG. 16 is generally similar to the image display device 81 of FIG. 1 except that it lacks the analog-to-digital converters 1r, 1g, 1b in FIG. 1. Instead, it has input terminals 9r, 9g, 9b that receive digital red, green, and blue image data SR2, SG2, SB2.

The input digital image data SR2, SG2, SB2 are supplied directly to the feature detection unit 2, white line detection unit 3, and smoothing units 5r, 5g, 5b. Other operations are similar to the operations of the image display device 81 shown in FIG. 1. Modifications similar to the modifications described for the image display device 81 in FIG. 1 are applicable to the fourth embodiment as well.

The invention is accordingly applicable to apparatus receiving digital red-green-blue image data instead analog red, green, and blue image signals.

### Fifth Embodiment

In the first embodiment, the feature detection unit detects bright areas adjacent to dark areas in the red, green, and blue image components individually, while the white line detection unit detects white lines on the basis of internally generated luminance data. In the fifth embodiment, the feature detection unit also uses the internally generated luminance data, instead of using the red, green, and blue image data.

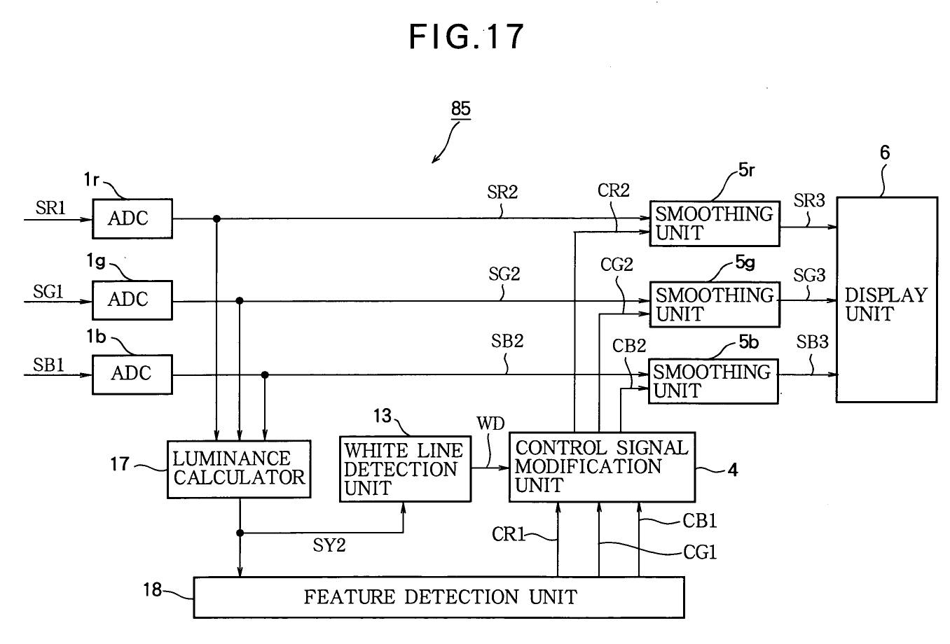

Referring to FIG. 17, the image display device 85 in the fifth embodiment of the invention is generally similar to the image display device shown in FIG. 1, except that it has an additional luminance calculator 17, uses the white line detection unit 13 of the second and third embodiments, and uses a feature detection unit 18 that differs from the feature detection unit 2 in FIG. 1.

The luminance calculator 17 calculates luminance values from the image data SR2, SG2, SB2 and outputs luminance data SY2. The luminance calculator 17 has a structure similar to that of the luminance calculator 31 in FIG. 3. Luminance data SY2 may be calculated according to the following equation, for example.

SY2={SR2+(2×SG2)+SB2}/4

The luminance data are supplied to both the white line detection unit 13 and the feature detection unit 18.

The white line detection unit 13 has, for example, the structure shown in FIG. 14.

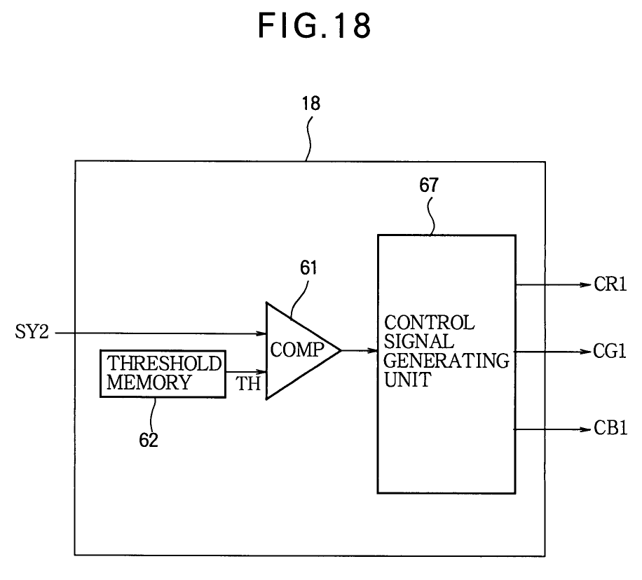

The feature detection unit 18 has, for example, the structure shown in FIG. 18. This structure is generally similar to the structure shown in FIG. 2, except that there are only one comparator 61 and one threshold memory 62, and the control signal generator 67 receives only the output of the single comparator 61. Dark-bright decisions are made on the basis of the luminance data SY2 instead of the red, green, and blue image data SR2, SG2, SB2, and a single decision is made for each pixel instead of separate decisions being made for the red, green, and blue cells of the pixel.

The threshold memory 62 stores a single predefined threshold TH. The comparator 61 compares the luminance data SY2 with the threshold stored in the threshold memory 62, and outputs a signal representing the comparison result. When the luminance data SY2 exceeds the threshold value, the pixel is classified as bright; otherwise, the pixel is classified as dark.

The control signal generator 67 uses the comparison results obtained by the comparator 61 to determine whether a pixel is in the bright part of a bright-dark boundary, and thus adjacent to the dark part. When a pixel is determined to be a bright part adjacent to a dark part, the first selection control signals CR1, CG1, CB1 for all three cells of the pixel are given the first value ‘1’; otherwise, all three control signals are given the second value ‘0’.

The operation of the image display device of FIG. 17 is generally similar to the operation described in the first embodiment, except for the operation of the feature detection unit 18.

In the feature detection unit 18 of FIG. 18, the luminance data SY2 are input to one of input terminals of the comparator 61. The threshold memory 62 supplies a predetermined luminance threshold value TH to the other input terminal of the comparator 61. The comparator 61 compares the luminance data SY2 and the luminance threshold TH. If the luminance value SY2 is equal to or less than the threshold value, the pixel is determined to be dark; otherwise, the pixel is determined to be bright.

Since the control signal generator 67 receives only a single luminance comparison result for each pixel, it can only tell whether the pixel as a whole is bright or dark, and applies this information to all three cells in the pixel. The control signal generator 67 comprises a memory and a microprocessor, for example, and uses them to carry out a predefined calculation on the dark-bright results received from the comparator 61 to generate the first selection control signals CR1, CG1, CB1. The control signal generator 67 may temporarily store the comparison results for a number of pixels, for example, and decide whether a pixel is a bright pixel adjacent to a dark area from the temporarily stored comparison results for the pixel itself and the pixels adjacent to it.

The operation of the white line detection unit 13 is similar to the operation of the white line detection unit 13 shown in FIG. 14.

Other operations of the fifth embodiment proceed as described in the first embodiment. The modifications mentioned in the first embodiment are also applicable to the fifth embodiment.

### Sixth Embodiment

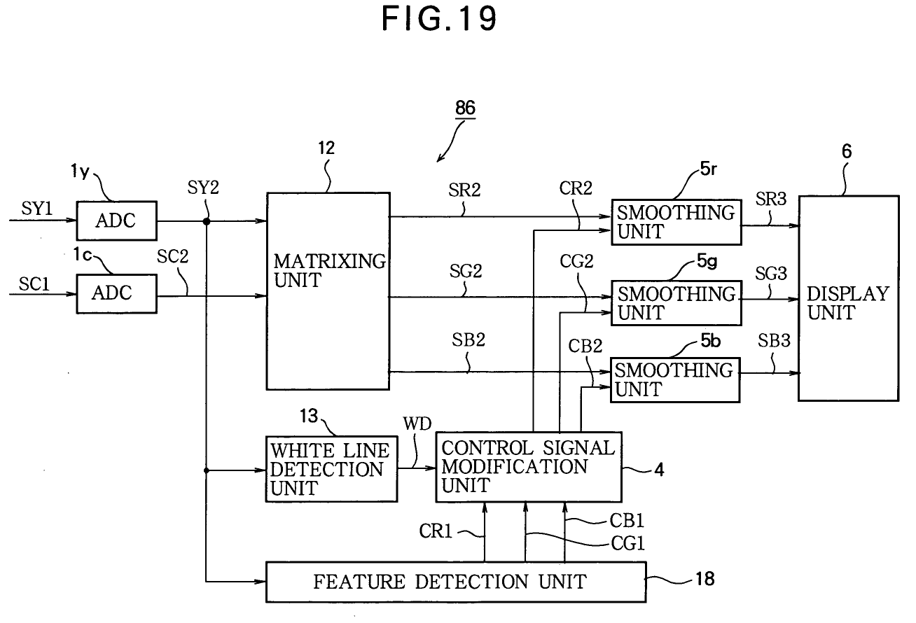

The image display device 86 in the sixth embodiment of the invention, shown in FIG. 19, is generally similar to the image display device 85 in the fifth embodiment but receives separate video input as in the second embodiment. That is, the image display device 86 in FIG. 19 receives a luminance signal SY1 and chrominance signal SC1 (including color difference signals BY and RY) as input image signals instead of the red, green, and blue image signals SR1, SG1, SB1 shown in FIG. 17. The luminance signal SY1 and chrominance signal SC1 are received by respective analog-to-digital converters 1y, 1c. The image display device 86 has a matrixing unit 12 that converts the digitized luminance data SY2 and color difference data SC2 output from the analog-to-digital converters to red, green, and blue image data SR2, SG2, SB2, but has no luminance calculator 17, since the white line detection unit 13 and feature detection unit 18 receive the luminance data SY2 directly from analog-to-digital converter 1y.

The feature detection unit 18 operates as described in the fifth embodiment, and the other elements in FIG. 19 operate as described in the first and second embodiments. Repeated descriptions will be omitted.

### Seventh Embodiment

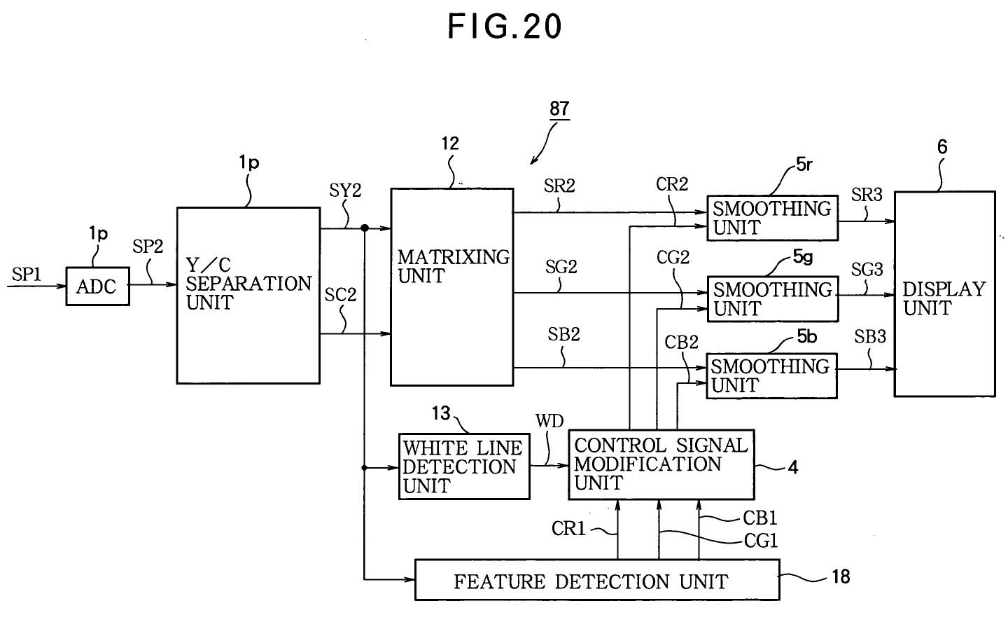

The image display device 87 in the seventh embodiment of the invention, shown in FIG. 20, is generally similar to the image display device 86 in the sixth embodiment, but receives a composite video signal SP1 as in the third embodiment instead of receiving separate video input. The image display device 87 has an analog-to-digital converter 1p, a luminance-chrominance separation unit 16, a matrixing unit 12, and a white line detection unit 13 that operate as in the third embodiment, and a feature detection unit 18 that operates as in the fifth embodiment, receiving the luminance data SY2 output by the luminance-chrominance separation unit 16. The control signal modification unit 4, smoothing units 5r, 5g, 5b, and display unit 6 operate as in the first embodiment.

### Eighth Embodiment

In the first to seventh embodiments, to detect bright areas adjacent to dark areas in an image, the feature detection units 2 and 18 make threshold comparisons to decide if a pixel is bright or dark. An alternative method is to make this decision by detecting the differences in luminance between the pixel in question and, for example, its left and right adjacent pixels. In this method, a pixel is recognized as being in a bright area adjacent to a dark area if its luminance value is higher than the luminance value of either one of the adjacent pixels.

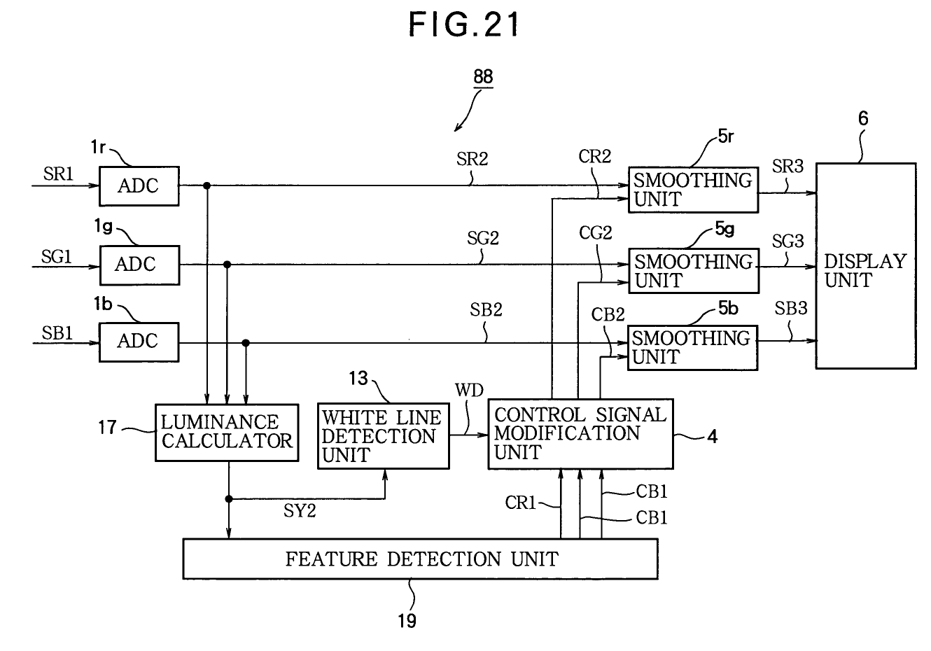

This method is used in the image display device in the eighth embodiment, shown in FIG. 21. This image display device 88 is generally similar to the image display device 85 in the fifth embodiment, but has a feature detection unit 19 that differs from the feature detection unit 18 shown in FIG. 17.

Referring to FIG. 22, the feature detection unit 19 in the eighth embodiment includes the same comparator 61 and threshold memory 62 as the feature detection unit 18 in FIG. 18, but also includes a first-order differentiator 63. The 67 receives the outputs of both the comparator 61 and first-order differentiator 63, and therefore operates differently from the control signal generator 67 in the fifth embodiment.

In the feature detection unit 19 in FIG. 22, the luminance data SY2 are input to both the comparator 61 and the first-order differentiator 63. The first-order differentiator 63 takes the first derivative of the luminance data by taking differences between the luminance values of successive pixels and supplies the results to the control signal generator 67. The comparator 61 compares the luminance data with a threshold TH stored in the threshold memory 62 and sends the control signal generator 67 a comparison result signal indicating whether the luminance of the pixel is equal to or less than the threshold or not, as in the fifth embodiment.

The control signal generator 67 carries out predefined calculations on the first derivative data obtained from the first-order differentiator 63 and the comparison results obtained from the comparator 61, and outputs first selection control signals CR1, CG1, CB1. The control signal generator 67 may comprise a microprocessor with memory, for example, as in the fifth embodiment.

For each pixel, based on the comparison results obtained from the comparator 61 and the first derivatives obtained from the first-order differentiator 63, the control signal generator 67 sets the first selection control signals CR1, CG1, CB1 identically to the first value ‘1’ or the second value ‘0’. If, for example, the first derivative value of a given pixel is obtained by subtracting the luminance value of the pixel adjacent to the left (the preceding pixel) from the luminance value of the given pixel, then the control signal generator 67 may operate as follows: if the first derivative of the given pixel is positive, indicating that the given pixel is brighter than the preceding pixel, or if the first derivative of the following pixel (the pixel adjacent to the right) is negative, indicating that the given pixel is brighter than the following pixel, and if in addition the luminance value of the given pixel is equal to or less than the threshold TH, then the first selection control signals CR1, CG1, CB1 of the given pixel are set uniformly to the first value ‘1’; otherwise, the first selection control signals CR1, CG1, CB1 of the given pixel are set uniformly to the second value ‘0’. In other words, the control signals are set to ‘1’ if the pixel is brighter than one of its adjacent pixels, but is not itself brighter than a predetermined threshold value.

The white line detection unit 13 operates as described in the fifth embodiment. The control signal modification unit 4, smoothing units 5r, 5g, 5b, and display unit 6 operate as described in the first embodiment. The operation of the eighth embodiment therefore differs from the operation of the preceding embodiments as follows. In the preceding embodiments, absolutely bright pixels are smoothed if they are adjacent to absolutely dark pixels, unless they constitute part of a white line (where ‘absolutely’ means ‘relative to a fixed threshold’). In the eighth embodiment, absolutely bright pixels are not smoothed, but absolutely dark pixels are smoothed if they are bright in relation to an adjacent pixel, unless they constitute part of a (relatively) white line.

FIGS. 23A, 23B, and 23C show exemplary gray levels in images with various bright-dark boundaries before smoothing. The vertical axis represents gray level, indicating brightness, and the horizontal axis represents horizontal pixel position PP on the screen of the display unit 6. R0d to R14d represent red cells, G0d to G14d represent green cells, and B0d to B14d represent blue cells. FIG. 23A illustrates gray levels when an image having a bright area on the left side that grades into a dark area on the right side is displayed. FIG. 23B illustrates gray levels when an image having a dark area on the left side that grades into a bright area on the right side is displayed. FIG. 23C illustrates gray levels in an image having two parallel vertical white lines, each one pixel wide, displayed on a dark background. The pixels correspond to cell sets ST0 to ST14 of three consecutive cells each.

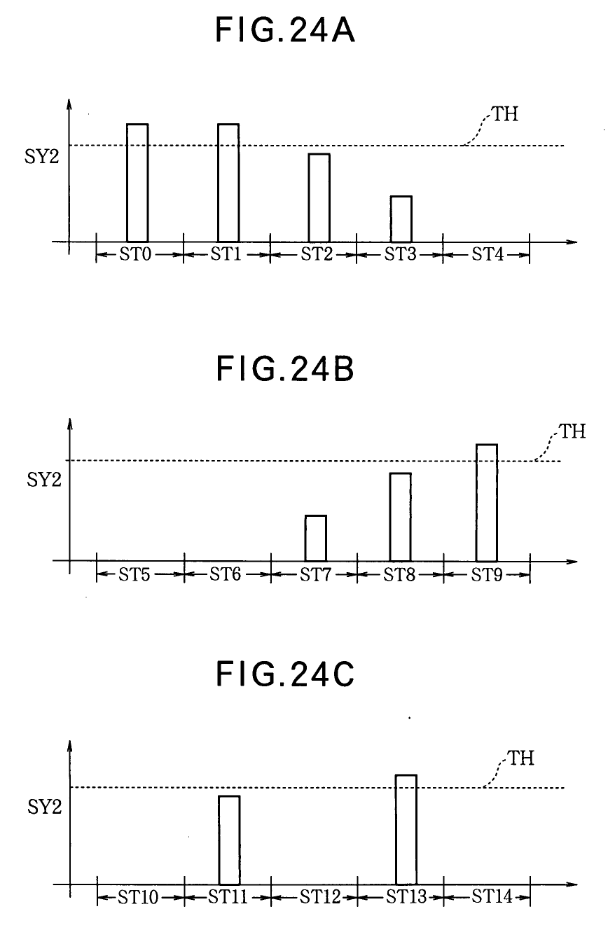

FIGS. 24A, 24B, and 24C indicate the luminance values SY2 of the cell sets or pixels shown in FIGS. 23A, 23B, and 23C. The threshold value TH in FIGS. 24A, 24B, and 24C is the value stored in the threshold memory 62 in the feature detection unit 19 shown in FIG. 22, with which the luminance data SY2 are compared.

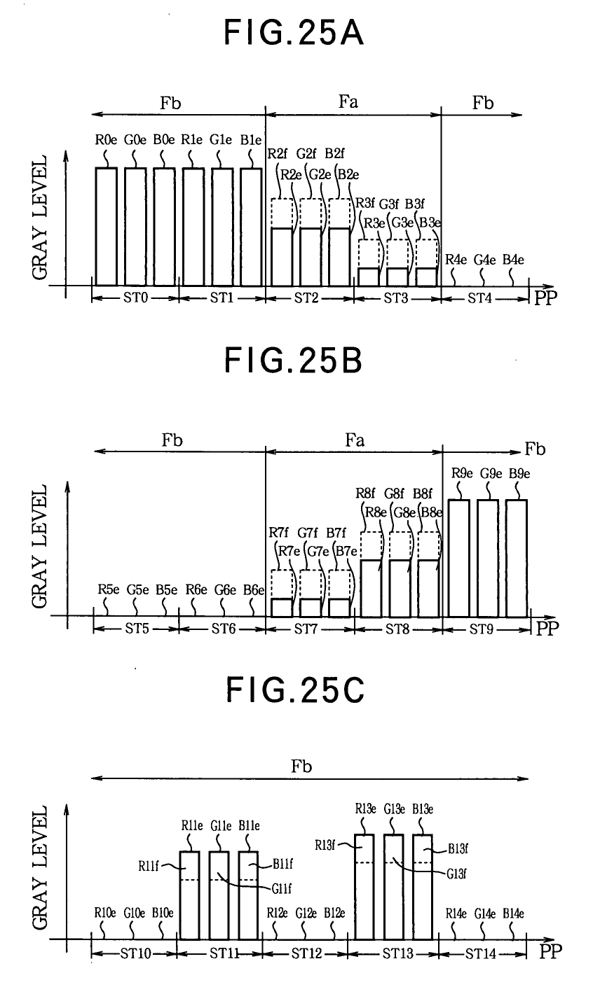

FIGS. 25A, 25B, and 25C show the results of selective smoothing carried out on the image data in FIGS. 23A to 23C by the smoothing units 5r, 5g, 5b controlled by the feature detection unit 19, white line detection unit 13, and control signal modification unit 4 in the eighth embodiment. As in FIGS. 23A, 23B, and 23C, the vertical axis represents gray level, the horizontal axis represents horizontal pixel position PP on the screen of the display unit 6, R0e to R14e are red cells, G0e to G14e are green cells, and B0e to B14e are blue cells.

The symbol Fa indicates that the cell set data shown below were processed by the first filter 52 with filtering characteristic A; the symbol Fb indicates that the cell set data shown below were processed by the second filter 53 with filtering characteristic B.

In FIGS. 23A and 24A, the luminance value SY2 calculated from the image data for the cells R0d, G0d, B0d, R1d, G1d, B1d in cell sets ST0 and ST1 exceeds the threshold TH, and the luminance values calculated from the image data for the cells in the other cell sets ST2, ST3, ST4 are lower than the threshold TH.

The luminance value calculated from the image data for the cells R2d, G2d, B2d in cell set ST2 exceeds the luminance value calculated from the image data for the cells R3d, G3d, B3d in cell set ST3. The luminance value calculated from image data for the cells R3d, G3d, B3d in cell set ST3 exceeds the luminance value calculated from image data for the cells R4d, G4d, B4d in cell set ST4.

Therefore, for cell sets ST2 and ST3, the first selection control signals CR1, CG1, CB1 output from the control signal generator 67 have the first value ‘1’. For cell sets ST0, ST1, and ST4, the first selection control signals CR1, CG1, CB1 have the second value ‘0’.

In FIGS. 23B and 24B, the luminance value SY2 calculated from the image data of the cells R9d, G9d, B9d in cell set ST9 exceeds the threshold TH, and the luminance values calculated from the image data of cell sets ST5 to ST8 are lower than the threshold TH.

The luminance value calculated from the image data of the cells R8d, G8d, B8d in cell set ST8 exceeds the luminance value calculated from the image data of the cells R7d, G7d, B7d in cell set ST7. The luminance value calculated from the image data of the cells R7d, G7d, B7d in cell set ST7 exceeds the luminance value calculated from the image data of the cells R6d, G6d, B6d in cell set ST6.

Therefore, the first selection control signals CR1, CG1, CB1 output from the control signal generator 67 for cell sets ST7 and ST8 have the first value ‘1’, but for cell sets ST5, ST6, and ST9, the first selection control signals CR1, CG1, CB1 have the second value ‘0’.

In FIGS. 23C and 24C, the luminance value SY2 calculated from the image data of the cells R11d, G11d and B11d in cell set ST11 exceeds the luminance value calculated from the image data of the cells in adjacent cell sets ST10 and ST12. The luminance value SY2 calculated from the image data of the cells R13d, G13d, B13d in cell set ST13 exceeds the luminance value calculated from the image data of the cells in adjacent cell sets ST12 and ST14. The luminance value SY2 calculated from the image data of the cells R13d, G13d, B13d in cell set ST13 also exceeds the threshold TH, whereas the luminance value calculated from the image data of the cells in cell sets ST10 to ST12 and ST14 is lower than the threshold TH.

Therefore, for cell set ST11, the first selection control signals CR1, CG1, CB1 output from the control signal generator 67 have the first value ‘1’ but the white line detection signal WD output from the white line detection unit 13 also has the first value ‘1’, so the second selection control signals CR2, CG2, CB2 have the second value ‘0’. For cell sets ST10 and ST12 to ST14, the first selection control signals CR1, CG1, CB1 have the second value ‘0’, so the second selection control signals CR2, CG2, CB2 again have the second value ‘0’.

As in the preceding embodiments, even if the first selection control signals CR1, CG1, CB1 output from the feature detection unit 19 have the first value ‘1’, when a white line is detected by the white line detection unit 13, the first selection control signals CR1, CG1, CB1 are modified by the white line detection signal WD, and the second selection control signals CR2, CG2, CB2 output from the control signal modification unit 4 have the second value ‘O’.

In the examples shown in FIGS. 23A-23C and 24A-24C, cell sets ST2, ST3, ST7, and ST8 are not detected as white lines. Their second selection control signals CR2, CG2, CB2 thus retain the value of the first control signals CR1, CG1, CB1, and since this is the first value ‘1’, smoothing is carried out by the first filter 52 with filtering characteristic A.

Cell sets ST11 and ST13 are detected as white lines. The first selection control signals CR1, CG1, CB1 output from the control signal generator 67 have the first value ‘1’ for cell set ST11 and the second value ‘0’ for cell set ST13, but in both cases, since the white line detection signal WD has the first value ‘1’, the second selection control signals CR2, CG2, CB2 output from the control signal modification unit 4 have the second value ‘0’. As a result, the second filter 53 is selected and smoothing is carried out with filtering characteristic B; that is, no smoothing is carried out.

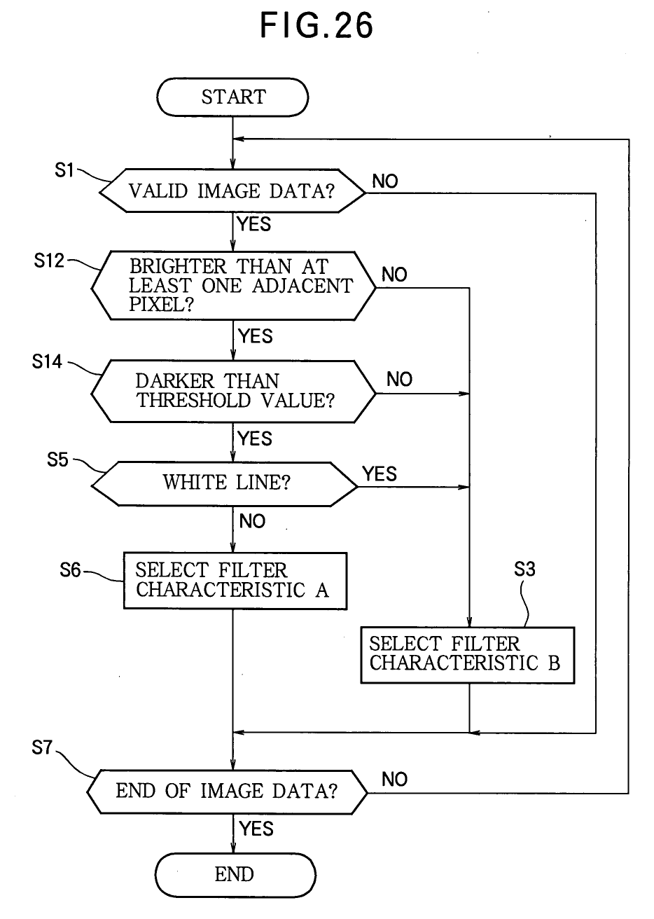

Next, the control of the smoothing units 5r, 5g, 5b by the feature detection unit 19, the white line detection unit 13, and the control signal modification unit 4 will be described with reference to the flowchart shown in FIG. 26. This control procedure can be implemented by software, that is, by a programmed computer.

The feature detection unit 19 determines if the input luminance data SY2 belong to a valid image interval (step S1). When they are not within the valid image interval, that is, when the data belong to a blanking interval, the process proceeds to step S7. Otherwise, the process proceeds to step S12.

In step S12, the control signal generator 67 determines whether the luminance value of the pixel in question exceeds the luminance value of at least one adjacent pixel, based on the first derivatives output from the first-order differentiator 63. If the luminance value of the pixel exceeds the luminance value of either one of the adjacent pixels, the process proceeds to step S14.

In step S14, the comparator 61 determines whether the luminance value of the pixel in question is below a threshold. If the luminance value is below the threshold, the process proceeds to step S5.

In step S5, the white line detection unit 13 determines if the pixel in question is part of a white line. If it is not part of a white line, the process proceeds to step S6.

In step S6, the second selection control signals CR2, CG2, CB2 are given the first value ‘1’ to select the first filter 52. The output of the first filter 52 is supplied to the display unit 6 as selectively smoothed image data SR3, SG3, SB3.

When the luminance value SY2 of the pixel in question does not exceed the luminance value of either adjacent pixel (No in step S12) or is not less than the threshold (No in step S14), or the pixel in question is determined to be part of a white line (Yes in step S5), the process proceeds from step S12, S14, or S5 to step S3.

In step S3, the second selection control signals CR2, CG2, CB2 are given the second value ‘0’ to select the second filter 53. The output of the second filter 53 is supplied to the display unit 6 as selectively smoothed image data SR3, SG3, SB3.

After step S3 or step S6, whether the end of the image data has been reached is determined (step S7). If the end of the image data has been reached (Yes in step S7), the process ends. Otherwise (No in step S7), the process returns to step S1 to detect further image data.

As a result of the above processing, the pixel luminance of cell sets ST2, ST3, ST7, and ST8 in FIGS. 23A and 23B is determined to exceed the luminance of at least one adjacent pixel (Yes in step S12), the luminance value is determined to be lower than the threshold (Yes in step S14), and the pixel is not detected as a white line by the white line detection unit 13 (No in step S5). The first selection control signals CR1, CG1, CB1 output from the feature detection unit 19 have the first value ‘1’, and the white line detection signal WD has the second value ‘0’. The value of the first selection control signals CR1, CG1, CB1 becomes the value of the second selection control signals CR2, CG2, CB2 without change. The first filter 52 is selected and smoothing is carried out with filtering characteristic A.

For cell set ST11 in FIG. 23C, as the luminance of the pixel in question is determined to exceed the luminance of at least one adjacent pixel (Yes in step S12) and the luminance value is determined to be lower than the threshold (Yes in step S14), the first selection control signals CR1, CG1, CB1 output from the feature detection unit 19 have the first value ‘1’, but the white line detection signal WD also has the first value ‘1’, so the second selection control signals CR2, CG2, CB2 have the second value ‘0’. The second filter (with filtering characteristic B) is selected, and no smoothing is carried out.

For cell set ST13, the pixel luminance value is determined to exceed the luminance of at least one of the adjacent pixels (Yes in step S12) but the luminance value exceeds the threshold (No in step S14), so the first selection control signals CR1, CG1, CB1 output from the feature detection unit 19 have the second value ‘0’ and the second selection control signals CR2, CG2, CB2 therefore also have the second value ‘0’. The second filter (with filtering characteristic B) is selected and no smoothing is carried out.

For the other cell sets ST0, ST1, ST4, ST5, ST6, ST9, ST10, ST12, and ST14, the luminance value is determined to exceed the threshold (No in step S14), or not to exceed the luminance value of at least one adjacent pixel (No in step S12), so the first selection control signals CR1, CG1, CB1 have the second value ‘0’, and the second selection control signals CR2, CG2, CB2 also have the second value ‘0’. The second filter (with filtering characteristic B) is selected and no smoothing is carried out.

As a result of the above selective smoothing, the luminance of the image data of the cells R2e, G2e, B2e, R3e, G3e, B3e, R7e, G7e, B7e, R8e, G8e, B8e in cell sets ST2, ST3, ST7, and ST8 in FIGS. 25A and 25B decreases. The decrease is represented by the symbols R2f, G2f, B2f, R3f, G3f, B3f, R7f, G7f, B7f, R8f, G8f, and B8f in FIGS. 25A and 25B.

In FIG. 25C, the luminance values of the image data of the cells R11e, G11e, B11e, R13e, G13e, B13e in cell sets ST11 and ST13 is not decreased. If the selector 51 were to be controlled by the first selection control signals CR1, CG1, CB1 output from the feature detection unit 19 without using the white line detection unit 13, the luminance values in cell set ST11 would decrease by the amount represented by the symbols R11f, G11f, and B11f. If the selector 51 were to be controlled by the first selection control signals CR1, CG1, CB1 output from the feature detection units 2, 18 in the preceding embodiments without using the white line detection units 3, 13, the luminance values in cell set ST13 would also decrease, by the amount represented by the symbols R13f, G13f, and B13f. The white line detection unit 13 enables these unwanted decreases to be avoided, so that the visibility of white lines on a dark background is maintained.

As shown in FIG. 25A or 25B, except for white lines, in an area where the luminance changes from dark to less dark, the less dark pixel is smoothed and thereby darkened. Thus, the gray level (brightness) of the image never increases, but at the boundary between a dark part and a less dark part, the gray levels of the boundary pixels that are below a predetermined threshold are further reduced, to emphasize the dark part at the expense of the brighter part, thereby compensating for the greater inherent visibility of the less dark part.

By taking the first derivative of the luminance data, the eighth embodiment can improve the visibility of dark features displayed on a relatively bright background even if the relatively bright background is not itself particularly bright, but merely less dark. This is a case in which improved visibility is especially desirable. Moreover, by detecting narrow white lines, the eighth embodiment can avoid decreasing their visibility by reducing their brightness, even if the white line in question is not an intrinsically bright line but rather an intrinsically dark line that appears relatively bright because it is displayed on a still darker background. This is a case in which reducing the brightness of the line would be particularly undesirable.

The eighth embodiment described above is based on the fifth embodiment, but it could also be based on the sixth or seventh embodiment, to accept separate video input or composite video input, by replacing the feature detection unit 18 in FIG. 19 or 20 with the feature detection unit 19 shown in FIG. 22.

The first to fourth embodiments can also be modified to take first derivatives of the red, green, and blue image data SR2, SG2, SB2 and generate first selection control signals CR1, CG1, CB1 for these three colors individually by the method used in the eighth embodiment for the luminance data.

As described, the invented image display device improves the visibility of dark features on a bright background, and preserves the visibility of fine bright features such as lines and text on a dark background, by selectively smoothing dark-bright edges that are not thin bright lines so as to decrease the gray level of the bright part of the edge without raising the gray level of the dark part.

A few modifications of the preceding embodiments have been mentioned above, but those skilled in the art will recognize that further modifications are possible within the scope of the invention, which is defined in the appended claims.

What is claimed is:

1. An image display device for displaying an image according to image data, comprising:
a feature detection unit for detecting, from the image data, bright parts of the image that are adjacent to dark parts of the image, the bright parts having a higher brightness than the dark parts, and thereby generating a first selection control signal;
a white line detection unit for detecting parts of the image that are adjacently between darker parts of the image, and thereby generating a white line detection signal;
a control signal modification unit for modifying the first selection control signal according to the white line detection signal and thereby generating a second selection control signal;
a smoothing unit for selectively performing a smoothing process on the input image data according to the second selection control signal, thereby generating selectively smoothed image data; and
a display unit for displaying the image according to the selectively smoothed image data.

2. The image display device of claim 1, wherein the control signal modification unit generates the second selection control signal so that when the first selection control signal indicates a bright part adjacent to a dark part and the white line detection signal does not indicate detection of a white line, the smoothing unit processes the image data with a first filtering characteristic, and when the first selection control signal indicates a bright part adjacent to a dark part and the white line detection signal indicates detection of a white line, the smoothing unit processes the image data with a second filtering characteristic having less smoothing effect than the first filtering characteristic.

3. The image display device of claim 2, wherein the second filtering characteristic has no smoothing effect.

4. The image display device of claim 1, wherein the white line detection unit generates the white line detection signal according to luminance data in the image data.

5. The image display device of claim 4, wherein the white line detection unit takes a second derivative of the luminance data.

6. The image display device of claim 1, wherein:
the feature detection unit generates a separate first selection control signal for each of three colors in the image data;
the control signal modification unit modifies the first selection control signal of each of the three colors according to the white line detection signal and thereby generates a separate second selection control signal for each of the three colors; and
the smoothing unit performs the smoothing process on the image data of each of the three colors according to the corresponding second selection control signal.

7. The image display device of claim 1, wherein the feature detection unit generates the first selection control signal according to luminance data in the image data.

8. The image display device of claim 1, wherein the feature detection unit detects parts of the input image brighter than a threshold value that are adjacent to parts of the input image darker than the threshold value as said bright parts of the image that are adjacent to dark parts of the image.

9. The image display device of claim 1, wherein the feature detection unit detects parts of the image that are brighter than adjacent parts of the image as said bright parts of the image that are adjacent to dark parts of the image.

10. The image display device of claim 9, wherein the feature detection unit detects only parts of the image that are darker than a predetermined threshold value as said bright parts of the image that are adjacent to dark parts of the image.

11. A method of displaying an image according to image data, comprising:
detecting, from the image data, bright parts of the image that are adjacent to dark parts of the image, the bright parts having a higher brightness than the dark parts, and thereby generating a first selection control signal;
detecting parts of the image that are adjacently between darker parts of the image and thereby generating a white line detection signal;
modifying the first selection control signal according to the white line detection signal and thereby generating a second selection control signal;
selectively performing a smoothing process on the image data according to the second selection control signal, thereby generating selectively smoothed image data; and
displaying the image according to the selectively smoothed image data.

12. The method of claim 11, wherein when the first selection control signal indicates a bright part adjacent to a dark part and the white line detection signal does not indicate detection of a white line, the second selection control signal causes the image data to be processed with a first filtering characteristic, and when the first selection control signal indicates a bright part adjacent to a dark part and the white line detection signal indicates detection of a white line, the second selection control signal causes the image data to be processed with a second filtering characteristic having less smoothing effect than the first filtering characteristic.

13. The method of claim 12, wherein the second filtering characteristic has no smoothing effect.

14. The method of claim 11, wherein the white line detection signal is generated according to luminance data in the image data.

15. The method of claim 14, wherein the white line detection signal is generated by taking a second derivative of the luminance data.

16. The method of claim 11, wherein:
generating a first selection control includes generating a separate first selection control signal for each of three colors in the image data;
modifying the first selection control signal includes modifying the first selection control signal of each of the three colors according to the white line detection signal, thereby generating a separate second selection control signal for each of the three colors; and
selectively performing a smoothing process includes performing a smoothing process on the image data of each of the three colors according to the corresponding second selection control signal.

17. The method of claim 11, wherein the first selection control signal is generated according to luminance data in the image data.

18. The method of claim 11, wherein detecting bright parts of the image that are adjacent to dark parts of the image includes detecting parts of the image brighter than a threshold value that are adjacent to parts of the image darker than the threshold value.

19. The method of claim 11, wherein detecting bright parts of the image that are adjacent to dark parts of the image includes detecting parts of the image that are brighter than adjacent parts of the image.

20. The method of claim 19, wherein said parts of the image that are brighter than adjacent parts of the image are detected as said bright parts of the image that are adjacent to dark parts of the image only if they are darker than a predetermined threshold value.
